(19) United States
(12) Patent Application Publication
(10) Pub. No.: US 2022/0198049 A1
(43) Pub. Date: Jun. 23, 2022

(54) Blockchain-Based Secure Email System

(71) Applicant: ZEU TECHNOLOGIES, INC., Montreal (CA)

(72) Inventors: Francois DUMAS, Montreal (CA); Yuming QIAN, Richmond Hill (CA); Patricia Popert-Fortier, Dorval (CA)

(73) Assignee: ZEU TECHNOLOGIES, INC., Montreal, QC (CA)

(21) Appl. No.: 17/432,040

(22) PCT Filed: Feb. 28, 2020
(86) PCT No.: PCT/CA2020/050267

§ 371 Date: Aug. 18, 2021

Related U.S. Application Data
(60) Provisional application No. 62/812,615, filed on Mar. 1, 2019.

(51) Int. Cl. G06F 21/62; H04L 9/40; H04L 9/30

(52) U.S. Cl. CPC G06F 21/6227; H04L 63/0442; H04L 2209/56; H04L 2209/38; H04L 9/30

(57) ABSTRACT

This patent describes a complete blockchain email system that supports both internal and cross-chain emails with the potential to interact with non-blockchain email systems. Through this method, as long as the sender or the recipient of the email is a blockchain mailbox, the email information will be recorded in the blockchain to ensure the authenticity of the email. Moreover, when blockchain mailboxes exchange messages, the email information will be encrypted and stored in distributed storage where only the recipient can obtain the unique cypher key and storage location of the email, thereby ensuring the security of email transmissions.

### TECHNICAL FIELD

The present application relates generally to a secure email system and more specifically to a blockchain-based secure email system.

### BACKGROUND ART

Email is not as secure as we have allowed ourselves to believe. There are security vulnerabilities in the email servers, email clients, and webmail servers available on the market. The traditional email system authenticates only on the email server according to the user name and password, while the information itself is typically stored in plain text on the server. Therefore, vulnerabilities in email service can be exploited by malevolent actors to obtain sensitive information contained in the mailbox.

For traditional email systems, the transfer of an email message from sender to recipient goes through multiple computers between the two points. Not only does the user have access to the email, but also many other parties like mailbox holders, email service providers, and even the network provider may all have access to the email, and could modify the content of emails without notifying the user. In the current email transmission process, the content data is encapsulated in clear text and is exposed to universal ports, making the data easily intercepted. The email data information could be seized by monitoring network, equipment or software.

In addition to access security factors, the data of email systems is stored centrally. Vulnerabilities in the email storage service may leak important mail information or lead to email tampering. Failure of email services, either through software or hardware failures, may also lead to loss of important email messages. After accessing the computer through these vulnerabilities, an intruder can readily obtain the email address and the corresponding username, password and the content of emails. If there is an email address book, the intruder can also get the contact information of those people. There are also vulnerabilities in some email clients. Intruders can inject a Trojan Horse into special format emails. The user then executes the Trojan Horse when the email is opened, creating a potentially dangerous security risk.

In light of the vulnerabilities noted above, there is a need for more secure email systems.

### SUMMARY OF INVENTION

In accordance with one aspect of the present invention, there is provided a blockchain messaging system comprising: a first blockchain mail agent comprising: a first interface for communication with a first smart contract on a first blockchain; a second interface for communication with a shared storage; and a third interface for receiving a transmission request for a message from a sender to a recipient. The first blockchain mail agent receives the transmission request, determines that a mailbox of the recipient is in a blockchain, and upon determining: encrypts content of the message; saves the encrypted content to the shared storage at a storage index; and creates a smart contract request for the first smart contract. The first smart contract generates a transaction record and saves the transaction record in the first blockchain.

In accordance with another aspect of the present invention, there is provided a method of secure messaging using a blockchain. The method includes: receiving a transmission request for a message from a sender to a recipient, the sender having a sender account on the blockchain; generating a cypher key; encrypting content of the message using the cypher key; storing the encrypted content to a shared storage at a storage index; and encrypting the storage index and the cypher key with a public key of the recipient so that only the recipient having a private key corresponding to the public key of the recipient can access the storage index and cypher key.

### BRIEF DESCRIPTION OF DRAWINGS

In the figures, which illustrate by way of example only, embodiments of the present invention,

FIG. 1 is a simplified system architecture block diagram;

FIG. 2 is a simplified diagram illustrating sending and receiving email from mailboxes in the same blockchain;

FIG. 3 is a simplified diagram illustrating the internal logic of a blockchain mail agent;

FIG. 4 is a simplified diagram illustrating internal logic of mail transfer agent (MTA);

FIG. 5 is a simplified diagram illustrating a detailed process of sending cross-chain email; and

FIG. 6 is a simplified diagram illustrating two services: one for sending email, and another one for checking email.

### DESCRIPTION OF EMBODIMENTS

A description of various embodiments of the present invention is provided below. In this disclosure, the use of the word “a” or “an” when used herein in conjunction with the term “comprising” may mean “one”, but it is also consistent with the meaning of “one or more”, “at least one” and “one or more than one.” Any element expressed in the singular form also encompasses its plural form. Any element expressed in the plural form also encompasses its singular form. The term “plurality” as used herein means more than one, for example, two or more, three or more, four or more, and the like. Directional terms such as “top”, “bottom”, “upwards”, “downwards”, “vertically” and “laterally” are used for the purpose of providing relative reference only, and are not intended to suggest any limitations on how any article is to be positioned during use, or to be mounted in an assembly or relative to an environment.

The terms “comprising”, “having”, “including”, and “containing”, and grammatical variations thereof, are inclusive or open-ended and do not exclude additional, un-recited elements and/or method steps. The term “consisting essentially of” when used herein in connection with a composition, use or method, denotes that additional elements, method steps or both additional elements and method steps may be present, but that these additions do not materially affect the manner in which the recited composition, method, or use functions. The term “consisting of” when used herein in connection with a composition, use, or method, excludes the presence of additional elements and/or method steps.

A “blockchain” is a tamper-evident, shared digital ledger that records transactions in a public or private peer-to-peer network of computing devices. The ledger is maintained as a growing sequential chain of cryptographic hash-linked blocks.

A “node” is a device on a blockchain network. The device is typically be a computer having a processor interconnected to a processor readable medium including memory, having processor readable instructions thereon.

In addition, the terms “first”, “second”, “third” and the like are used for descriptive purposes only and cannot be interpreted as indicating or implying relative importance.

In the description of the invention, it should also be noted that the terms “mounted”, “linked” and “connected” should be interpreted in a broad sense unless explicitly defined and limited otherwise. For example, it could be fixed connection, or assembled connection, or integrally connected; either hard-wired or soft-wired; it may be directly connected or indirectly connected through an intermediary. For technical professionals, the specific meanings of the above terms in the invention may be understood in context.

In the drawings illustrating embodiments of the present invention, the same or similar reference labels correspond to the same or similar parts. In the description of the invention, it should be noted that the meaning of “a plurality of” means two or more unless otherwise specified; The directions or positions of the terms “up”, “down”, “left”, “right”, “inside”, “outside”, “front end”, “back end”, “head”, “tail”, the orientation or positional relationship shown in the drawings is merely for the convenience of describing the invention and simplifying the description rather than indicating or implying that the indicated device or element must have a particular orientation and be constructed and operated in a particular orientation, and therefore cannot be used as a limitation of the invention.

A combination of blockchain technology and email technology can effectively solve the problems identified in the background section. The blockchain authenticates the sender and the recipient of the blockchain email. This authentication cannot be forged. All content and attachments are encrypted with the other party's encryption key and stored on the distributed storage service. Third parties cannot obtain all of the data. Should the data be illegally retrieved, it is still not possible to decrypt the corresponding data without the appropriate key. All email content and attachments are processed, signed by the sender to generate fingerprint information, and stored in the blockchain, which means the sender's public key can verify the email for accuracy at any time. The recipient decrypts the data using their private key and verifies the data fingerprint on the blockchain to ensure that the data is not altered or forged. This fully distributed decentralized email system can fundamentally guarantee the security of email.

In the real world, it is almost impossible for all users to utilize the same blockchain system. Therefore, there are multiple alliance chains that do not interact with each other. However, as an email system, it is imperative to provide cross-chain email interoperability, as well as blockchain email and communication with regular Internet email. When interacting with ordinary mailboxes, information security issues are not covered in this patent because ordinary mailboxes are transmitted or stored in plain text; however, we can still use the blockchain feature to guarantee the authenticity of all sent or received messages. Furthermore, for blockchain-to-blockchain mailboxes, the email transmission will be encrypted end to end, and only the authorized recipient can read the mail.

The present specification describes a blockchain email system that supports both internal and cross-chain emails with the potential to interact with non-blockchain email systems. Through this method, as long as the sender or the recipient of the email is a blockchain mailbox, the email information will be recorded in the blockchain to ensure the authenticity of the email. Moreover, when blockchain mailboxes exchange messages, the email information will be encrypted and stored in distributed storage; only the recipient can obtain the unique cypher key and storage location of the email, thereby ensuring the security of email transmissions.

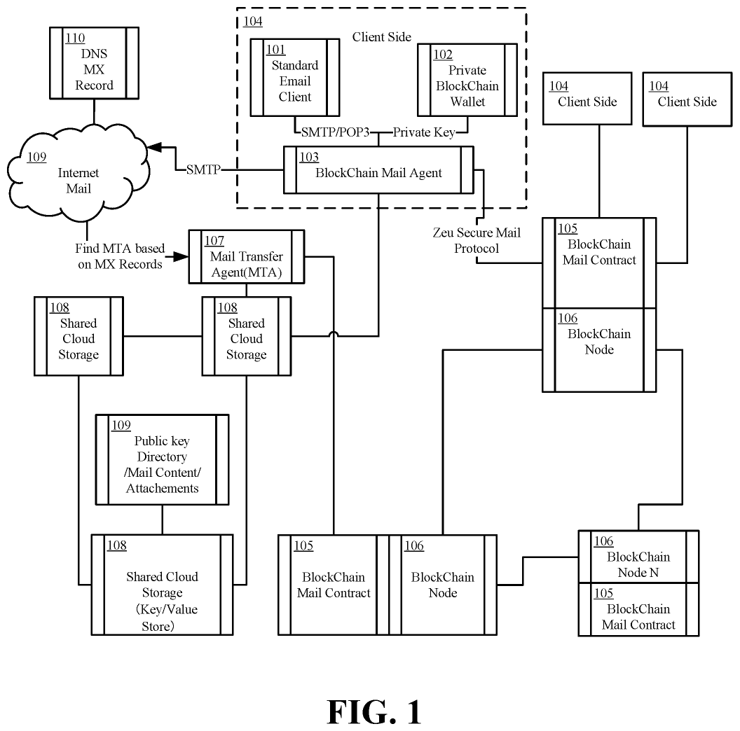

A system, exemplary of an embodiment of the invention, is described below. FIG. 1 depicts a system architecture diagram for an embodiment of the present invention. As illustrated, the system architecture diagram includes of the following components.

Component 101 is a standard email client. In order to adapt to different users' usage habits, an email service is provided, for example as an email client plugin, to capture the content of the email via an internal protocol or a standard email protocol through a secure mail agent component 103. The agent identifies the blockchain email by the special tag in email content. If the email is normal email, the email will go through the traditional email server; otherwise, the email will be encrypted and sent through blockchain email service. Optionally, the local mail agent could provide POP3 and SMTP interface to local email clients, thus any third party email client could send/receive email through the secure local email agent service. To ensure information security, the Secure Mail Agent is required to run on the same node as the standard email client to prevent the non-secure mail messages from being transmitted and saved on the network.

Alternatively, the standard email client could have a plugin, which interacts with the email client's user interface (UI) to capture the content of the email. If email is identified as a blockchain email, the plugin will act as a secure mail agent and converts the secured blockchain email to a clear text email to be displayed on the email client's UI, or encrypts the clear text mail to blockchain email and sends to blockchain email service for further processing.

Component 102 is a blockchain wallet. The blockchain wallet's primary function is to store the user's private key and public key. We can associate an email account with a blockchain account using a wallet. Each blockchain email account sets the public key and the private key. The public key will be posted to shared cloud storage, and anyone can access it, while the wallet fully protects the private key. The data will be encrypted or decrypted by using the wallet API (Application Programming Interface). Since the wallet stores important blockchain account information and private keys, to avoid information leaks, we require the wallet to run on the user-side terminal to ensure that only the user can access the wallet.

Component 103 is a secure blockchain local email agent or plugin. The agent communicates with the local email client through private plugin protocol or through the POP3 and SMTP interface, and converts the email send/receive request into a blockchain smart contract request. The secured blockchain email message, which contains the encrypted storage index key and a common cypher for decryption, is sent and received through the smart contract running in the blockchain. Alternatively, the encrypted mail could send and receive through normal mail server, while using the plugin or the mail agent to verify the content and encrypt/decrypt the mails. The secure email agent registers the public key information of the local mailbox on the shared cloud storage. The recipient-side email agent monitors the blockchain to retrieve messages. After receiving the message, the private key in the wallet is used to decrypt and obtain the shared exclusive cypher key and the indexed data used in the shared cloud storage to obtain the corresponding encrypted email content and attachments. After retrieving the email content and attachments, the email agent uses the exclusive cypher key to decrypt the email content and forward it to local email. When the local email client application is not enabled, the agent is also responsible for locally caching various received messages.

Component 104 is a client side component. To ensure information security, components 101, 102, 103 are deployed together to form the client component 104.

Component 105 is a blockchain email smart contract. Smart contracts are used to record the encrypted exclusive cypher key of each email and the sender's signature information in the chain. Consensus is completed at the blockchain node for smart contracts, ensuring data is stored and unalterable. Since the cypher key stored in blockchain is encrypted by the recipient's public key, and the main email content and attachments are encrypted by the exclusive cypher key and stored in distributed cloud storage, only the recipient can retrieve the corresponding email information correctly. No one else, not even the administrator, knows where the email information is stored, nor can they intercept the content of the email; thus there is no way to decode the email. For all emails sent or received to the Internet mailbox, as long as one party is a blockchain mailbox, the signature information of the email will also be left in the blockchain for verification purposes.

Component 106 is a blockchain node. Component 106 is used to complete multi-node consensus and account recording work. This patent does not limit the specific blockchain; any blockchain system that can support smart contracts should be suitable. Furthermore, this patent works for multiple heterogeneous blockchain systems to exchange emails.

Component 107 is a Mail Transfer Agent (MTA). Component 107 is used for the interface gateway of Internet email. The MX (mail exchanger) information is registered on the domain name server so that all Internet email and other cross-chain blockchain emails are sent to the node for processing. When the MTA receives regular Internet email, it will sign the email with the MTA private key, obtain the recipient's public key according to the recipient information, encrypt the content, and forward it to the blockchain email. When the MTA receives a cross-chain email from another blockchain, it will send the message directly to the blockchain mailbox based on the recipient information.

Component 108 is a shared, cloud storage service component. Component 108 provides the basic Key/Value mapping storage, and distributes data to multiple different nodes in a multi-copy distributed storage manner to ensure the efficiency and data security of the entire system. All users can publicly access the storage system. However, when the blockchain email is stored, the email information is encrypted and the corresponding KEY is encrypted, and only accessible by the recipient. Therefore, third parties cannot assemble the complete email and cannot decrypt it.

Component 109 depicts the at least three types of data which are stored on the shared cloud storage in this embodiment. The three types of data include: 1) corresponding public key information of the mailbox, and publicly accessible information; 2) encrypted email message content, which is used by the exclusive key of each email; and 3) encrypted large attachments. A symmetric encryption algorithm is used to encrypt the email content with the exclusive cypher key. The content format is MIME (Multipurpose Internet Mail Extensions). Therefore, small attachments could be encrypted together with email body as part of the encrypted email message content. Encrypted large attachments are similarly encrypted by an exclusive cypher key using a symmetric encryption algorithm.

Component 110 is a DNS (domain name system) service component. To fill in the MTA's IP (internet protocol) address on the MX record of the domain name, all email addressed to the domain name will be forwarded to assigned MTA.

A complete email system includes an email client, email server, and email transmission channel. The email itself typically includes sender, recipient, title, content, and multiple attachments. To integrate with the existing email system, the deployment of a system exemplary of an embodiment of the present invention is differentiated according to the recipient's mailbox domain name. The recipient may belong to the local mailbox in the same blockchain or in another blockchain. In other embodiments, the recipient's mailbox may also be an external Internet mailbox.

The process of sending and receiving of emails may be classified in accordance with the following scenarios.

### Email Processes

### Mail Delivery Processes

### Scenario 1: From Blockchain Mailbox to Blockchain Mailbox in the Same Chain

In this scenario, the email client first sends an email to the local blockchain email agent using the general mail protocol. The local agent determines whether the domain to which the multiple recipients in the email belong, has its mailbox in the local blockchain. If so, it generates a unique cypher key for this email, and saves the encrypted email body and attachments to a shared storage through encryption, and uses the sender's private key to sign the data to prevent illegal tampering by a third party. The local email agent simultaneously encrypts the shared storage index information and the email exclusive cypher key with the public key of the blockchain recipient's mailbox, pushes it to the email contract to generate a transaction record, saves it on the blockchain, and completes the consensus. If there are N recipients in the email then, N blockchain records are generated respectively, and the public key of the N recipients is used to encrypt the cypher key and index the information of the email on the shared storage.

After the implementation of this step, at least one email body will be retained in the shared storage, and the email agent generates N (number of recipients) blockchain records and completes the consensus on the chain.

### Scenario 2: From Blockchain Mailbox to Blockchain Mailbox in Another Chain

In this scenario, when sending an email, the local blockchain email agent queries the shared cloud storage to check whether the corresponding recipient email address is a blockchain mailbox. If it is a blockchain mailbox, it first generates a dedicated cypher key and encrypts the email with the cypher key. The encrypted mail content and attachments are stored in the shared cloud storage. The sender's blockchain email agent obtains the public key information of the recipient account from the shared cloud storage, and uses the public key to encrypt the exclusive cypher key and sends it to the mail transmission gateway (MTA) of the other party through regular Internet email. After receiving the blockchain email, the other party's MTA pushes a blockchain email to the party's blockchain email contract according to the recipient information.

In this scenario, cloud storage services shared by multiple blockchains are relied on in order to exchange cross-chain data. Since the data is shared, when the receiving agent receives the email information, the email body data must already exist and can only be decrypted by the other party's email; any intermediate node cannot know the email content, which ensures data security.

### Scenario 3: From Blockchain Mailbox to Normal Non-Encrypted Internet Mailbox

In this scenario, since the recipient is a non-encrypted Internet mailbox, responsibility for the security of the information does not rest with the exemplary embodiment of the systems. However, the exemplary system calculates fingerprint information for sent email's content and attachments, and uses the sender's private key to sign and authenticate the fingerprint information. The blockchain mailbox agent pushes the information to the blockchain email smart contract and saves the relevant information to the blockchain so that the recipient of the email can verify whether the email message has been tampered with according to the fingerprint information of the signature. These email records could also be used for legal purposes.

### Mail Recipient Processes

Mail reception may include the following scenarios:

Scenario 4: Receive a Blockchain Email from a Mailbox that Belongs to the Same Blockchain

The blockchain email agent monitors new messages on the blockchain. When the blockchain has generated an email transaction record for a recipient's current account, the blockchain email agent parses the message content, obtains the sender's public key to verify the signature, and uses the private key in the local wallet to decrypt the message body to obtain the mail storage index and the corresponding exclusive cypher key. The blockchain email agent uses the email storage index information to download the corresponding encrypted email content and attachments from the shared cloud storage service and decrypts the content using the exclusive cypher key. The decrypted email will be temporarily stored in the local post office. When the user opens the standard email client, the email client communicates with the local email agent using the standard POP3 protocol to obtain the decrypted email and attachments. This approach makes the user's blockchain mailbox experience no different from using a regular mailbox service.

Scenario 5: Receive a Cross-Chain Blockchain Email from a Mailbox on Another Blockchain

The blockchain email proxy service registers as an ordinary MX email service to the Internet domain name and saves the public key and domain name mapping of the blockchain email agent to the shared cloud storage service. When receiving a cross-chain blockchain email sent by a mailbox on another blockchain, MTA first obtains the sender's public key from the public key directory in the shared cloud storage service, verifies the email signature, and then pushes the encrypted exclusive cypher key and storage index information to the local blockchain email smart contract. When the local recipient receives the corresponding blockchain email message, the message will be treated the same as Scenario 1.

Scenario 6: Receive Regular Email from a Regular Internet Mailbox

Email sent from regular Internet mailboxes is unencrypted. In order to enable the blockchain mailbox to receive regular email sent through the Internet, the blockchain MTA needs to perform the email forwarding work: generate the exclusive cypher key, encrypt the contents and attachments of the message with the cypher key, save the encrypted email content and attachments to the shared cloud storage service, obtain the cloud storage index and search for the corresponding recipient mailbox public key in cloud storage according to the recipient mailbox, then use the public key to encrypt the cypher key and storage index. The exclusive cypher key is encrypted and signed with the private key of the email agent, and then pushed to the blockchain email contract to complete the local email forwarding. The recipient's blockchain mailbox client can receive regular Internet mail using the same process as Scenario 1.

### EXAMPLE

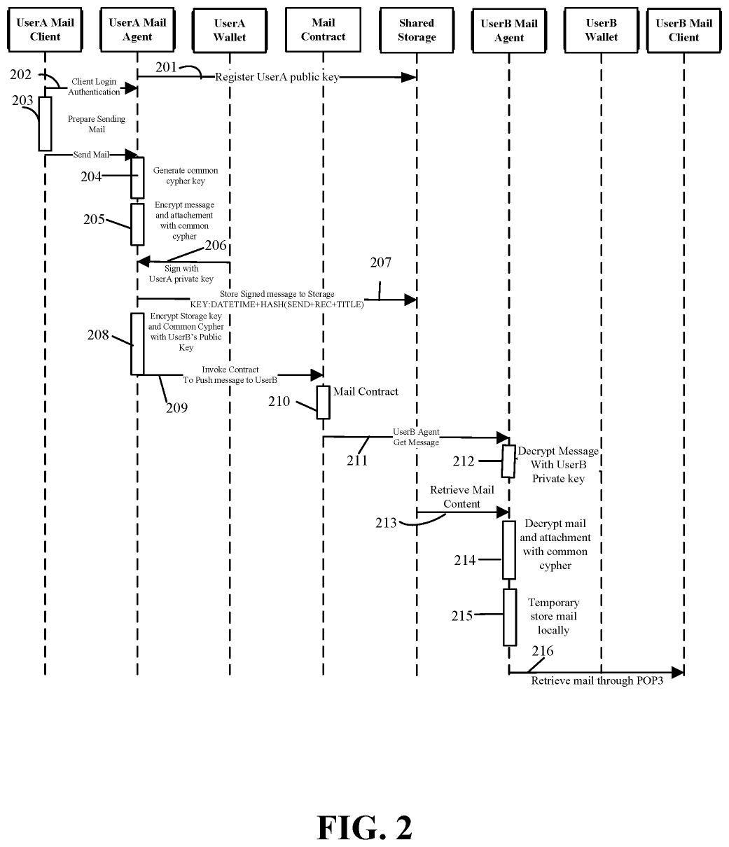

The following example is described with reference to FIG. 2 which depicts a schematic block diagram illustrating sending and receiving email from mailboxes in the same blockchain.

User A sends a blockchain email to User B's mailbox; they are both on the same blockchain.

At step 201 User A's email agent register get User A's public key from the wallet and register it to the shared storage. Thus, other users in the same chain or different chains could find the public key for user A.

At step 202 User A's email client perform authentication with local email agent through POP3 protocol.

At step 203 User A composes an email, and sends it to local email agent through SMTP.

At step 204 User A's local email agent receives an email send out request, and generates a unique exclusive cypher key.

At step 205 User A's local email agent uses this unique cypher key to encrypt the email content and attachments based on symmetric encryption methods.

At step 206 User A's local email agent calls the wallet, uses user A's private key to sign the encrypted email content and attachments, and generate a signature for this email.

At step 207 User A's local email agent stores the encrypted mail content and attachments to the shared cloud storage with index key (DATETIME+HASH(SENDER+recipient+TITLE)) or (DATETIME+HASH(SENDER+recipient+ATTACHMENT FILENAME)).

At step 208 User A's local email agent retrieves user B's (the recipient) public key from the shared storage, and encrypts the exclusive cypher key and cloud storage index keys with User B's public key based on asymmetric encryption. If there is more than one recipient, the local mail agent encrypts multiple times for each recipient.

At step 209 User A's local email agent invokes the email contract, pushes the encrypted exclusive cypher key and cloud index keys to the smart contract and stores it in the blockchain.

At step 210 The email contract performs the consensus operation in the blockchain and stores the messages on the blockchain.

At step 211 User B's email agent continues to monitor the blockchain. When the agent finds a message to User B, it retrieves the message from the blockchain.

At step 212 User B's email agent decrypts the message with user B's private key in the wallet based on asymmetric encryption methods.

At step 213 after decryption, User B's email agent retrieves the index for email content and attachments and the cypher key for this email. It retrieves the encrypted email content and attachment from the shared storage using the index.

At step 214 User B's email agent decrypts the email content and attachments with the cypher key based on symmetric encryption method.

At step 215 User B's email agent temporary stores the decrypted mail content and attachments in local storage.

At step 216 User B's email client retrieves the mail from User B's email agent using POP3 protocol or plugin and displays the message to User B.

### Three Types of Data in Shared Cloud Storage

The following three types of data are stored in the shared cloud storage.

Data Type 1: User Mailbox→Mailbox's Public Key Mapping

One exemplary format is as follows:

A string represents the user's mailbox as the only primary key in the format XX@[domain.com] where XX is the mailbox name, and domain.com is the domain name.

A string represents the public key of the mailbox. The format of the public key could be different for different key systems; it is recommended to express in PEM (Privacy Enhanced Mail) format.

Data Type 2: Mail Index→Encrypted Mail Content Mapping

A string represents the mail index. The structure is DATETIME+HASH(SENDER+recipient+TITLE), which makes it easier to group by date, which is convenient for hot and cold data exchange on cloud storage.

The standard MIME structure represents the content of the email. In one embodiment the structure may be as described in section 7.2 “The Multipart Content-Type” of RFC1341 entitled “MIME (Multipurpose Internet Mail Extensions): Mechanisms for Specifying and Describing the Format of Internet Message Bodies” available online at: https://www.w3.org/Protocols/rfc1341/7_2_Multipart.html, and the Wikipedia entry for MIME available online at: https://en.wikipedia.org/wiki/MIME.

The email TITLE, FROM, TO, CC, BCC, etc. are not encrypted, but the mail content and attachments are encrypted by AES (Advanced Encryption Standard) and other symmetric encryption algorithms and then combined into a string according to Base64 encoding.

Data Type 3: Attachment Index→Encrypt Attachment Data

To reduce the cost of getting mail, you can save large and oversized attachments separately.

The attachment index format is Mail Index—Attachment ID, which adds a large attachment by referring to the attachment index in the message.

The encryption method of the attachment and the content of the email is encrypted by using the exclusive cypher key of the email, and the exclusive cypher key is transmitted to the recipient through the blockchain.

### Internal Logic of Blockchain Mail Agent

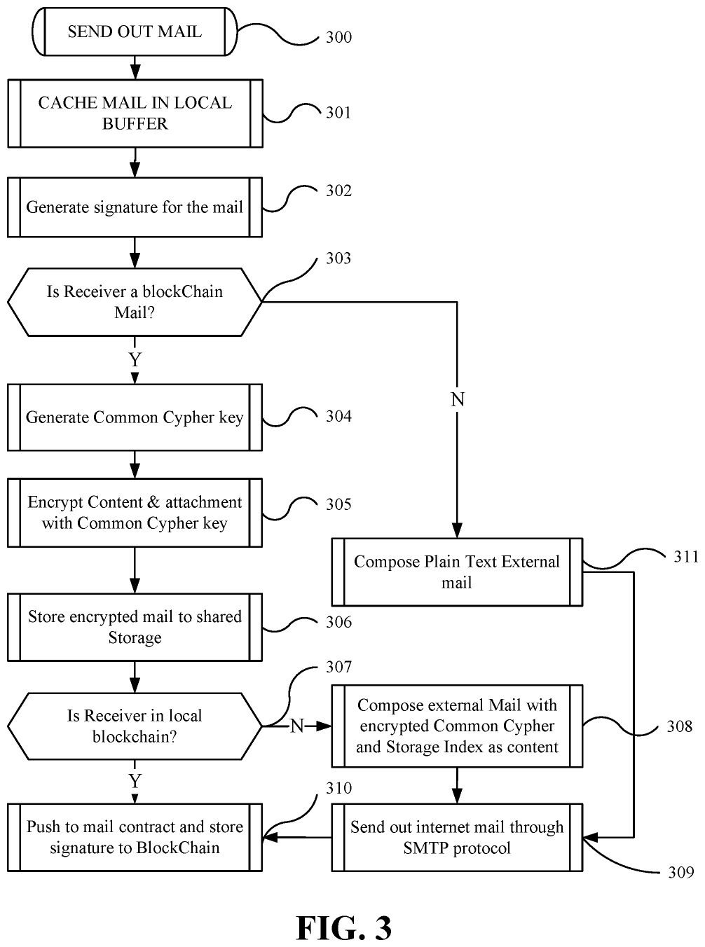

FIG. 3 depicts a flowchart representative of an internal logic for an embodiment of a process utilizing the Blockchain Mail Agent that includes the following steps.

At step 300 of the e process the client sends an email.

At step 301 Mail Agent caches pending email locally.

At step 302 the process signs the message with the sender's private key.

At step 303 the process queries shared cloud storage, checks whether the email recipient is registered with the blockchain mailbox.

At step 304 if a blockchain mailbox is registered in the shared storage, this means that the recipient is a blockchain mailbox, and an exclusive cypher key is generated.

At step 305 the process encrypts the message content and attachments using the exclusive cypher key.

At step 306 the process stores the encrypted mail and attachments to the shared cloud storage.

At step 307 the process checks whether the recipient is in the same blockchain.

At step 308 the process asks if the recipient is not in the same blockchain, builds an outgoing message with the encrypted exclusive cypher key and the storage index.

At step 309 the process sends Internet email using SMTP protocol.

At step 310 the process pushes the message to the email contract, saves the mail signature information, the encrypted exclusive cypher key, and the storage index information in the blockchain.

At step 311 the process, if the recipient of the email is not a blockchain mailbox, the process constructs a clear text message, sends the message and pushes the message to the email contract which only contains the email signature.

Internal Logic of Mail Transfer Agent (MTA)

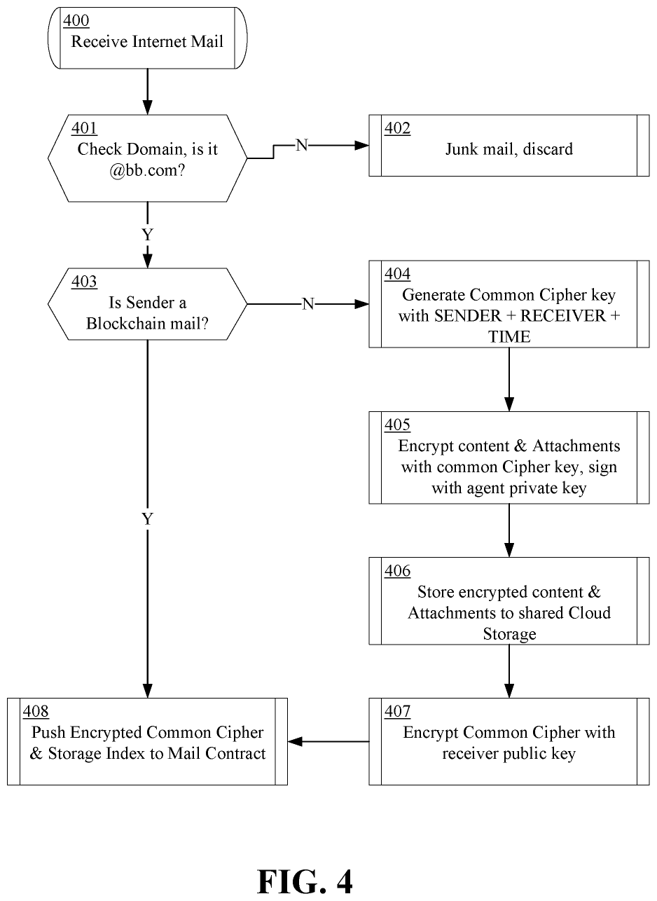

FIG. 4 depicts the Internal Logic of Mail Transfer Agent (MTA) including the following steps.

At step 400 of the process MTA receives an email from the Internet.

At step 401 the process checks the domain of the recipient.

At step 402 of the process if the domain is not the same as the currently registered domain, this is junk mail and is discarded.

At step 403 the process queries if the sender of the email is a blockchain mailbox.

At step 404 of the process, if the sender is not a blockchain mailbox, needs to convert regular internet email to blockchain email, and generates the common cipher key for encryption.

At step 405 the process encrypts the content & attachments with the exclusive cypher key, and signs the email with MTA private key.

At step 406 the process stores the encrypted content and attachments to the shared cloud storage.

At step 407 the process encrypts the exclusive cypher key and storage index with the recipient's public key.

At step 408 the process invokes the email contract, pushes the encrypted exclusive cypher key and storage index as a message to Blockchain email contract.

### Cross-Chain Email

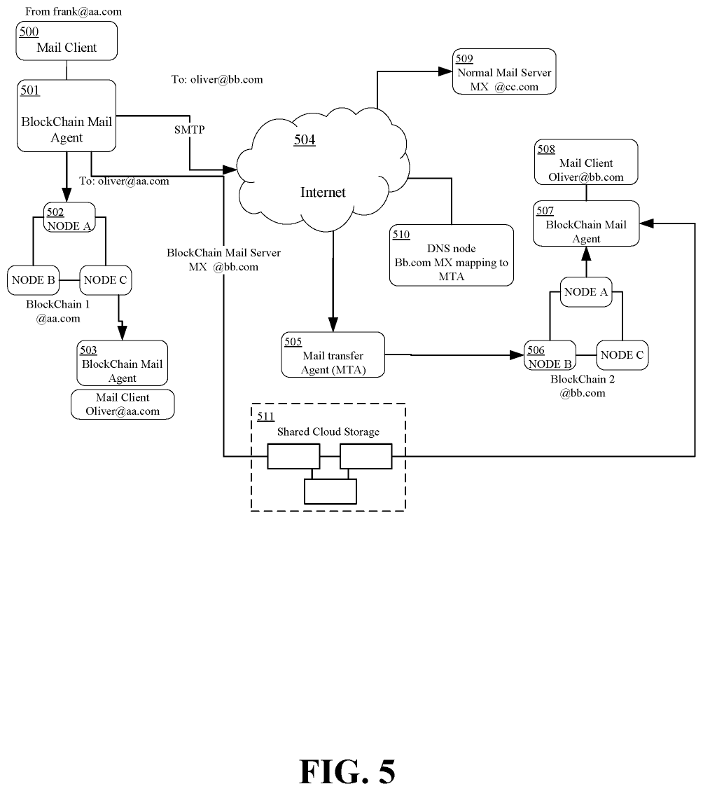

A detailed exemplary process of sending cross-chain email is described with reference to FIG. 5, which depicts elements or steps involved in sending cross-chain email. These include mail client 500, blockchain mail agent 501, node 502, blockchain mail agent 503, a network 504 such as the internet, a mail transfer agent (MTA) 505, node 506, blockchain mail agent 507, mail client 508, mail server 509, DNS node 510 and shared cloud storage 511.

In one exemplary embodiment, in order to support cross-chain blockchain email, the process first registers the MTA 505 to the MX record of the DNS service 510, so that the corresponding server can be found when sending email through the Internet protocol. To obtain the public key information of the recipient mailbox, the blockchain email agent needs to register its public key and email address to map to the cloud shared distributed storage. Then, the sender can encrypt the data using the recipient key, and verify the sender's signature information to ensure that the content is correct and not leaked to third parties.

To transfer cross-chain email content from one blockchain system to another, the process first generates a unique exclusive cypher key, and then sign it with the sender's private key on the sender's blockchain mail agent 501. The exclusive cypher key is used to encrypt the mail content and attachments using a symmetric encryption algorithm, and the encrypted email data is stored in the distributed cloud storage 511 that can be shared globally. External exposure of the key-value (K/V) access interface of distributed cloud storage is required in this embodment. The public key of the recipient mailbox is then used to encrypt the generated exclusive cypher key and the index position of the cloud storage with an asymmetric encryption algorithm. Since the encrypted data can only be decrypted by the private key of the recipient mailbox, it restricts the random forwarding of the secure email or the interception of email content which may cause security issues.

After completing the exclusive cypher key encryption, the process constructs a regular Internet email to transfer the information to the email service under the new domain name—Mail Transfer Agent 505. The MTA 505 then forwards the message contents to the blockchain system node 506, completes the blockchain consensus operation, and records the message into the blockchain account book. When the blockchain email agent 507 of the recipient client 508 detects the new mail, it decrypts the mail message using the private key of the mailbox in the local wallet, obtains the index address of the exclusive cypher key and the cloud storage 511, and retrieves the corresponding address in cloud storage 511. The email content and attachments use the exclusive cypher key for decryption for recipient client 508 to retrieve and display using standard mail protocols.

### Blockchain Smart Contract Logic

### Block Data Storage Format

| Messageid | FROM | TO | COMMONCYPHER | STORAGEKEY | SIGNATURE | DATETIME |
|---|---|---|---|---|---|---|
| 64 bit int | account | account | string | string | string | 64 bit int |

FROM: The sender's blockchain account

TO: The recipient's blockchain account

COMMONCYPHER: The encrypted common cypher

STORAGEKEY: The encrypted storage index key

SIGNATURE: The signature of mail

DATETIME: Sent time

If the email is from the Internet, the “From” field will be filled as the MTA's account. If the recipient of the email is outside of the current chain, the “To” field will be filled with null.

To avoid spam email, all users except the MTA is required to pay a certain amount of tokens based on the number of recipients.

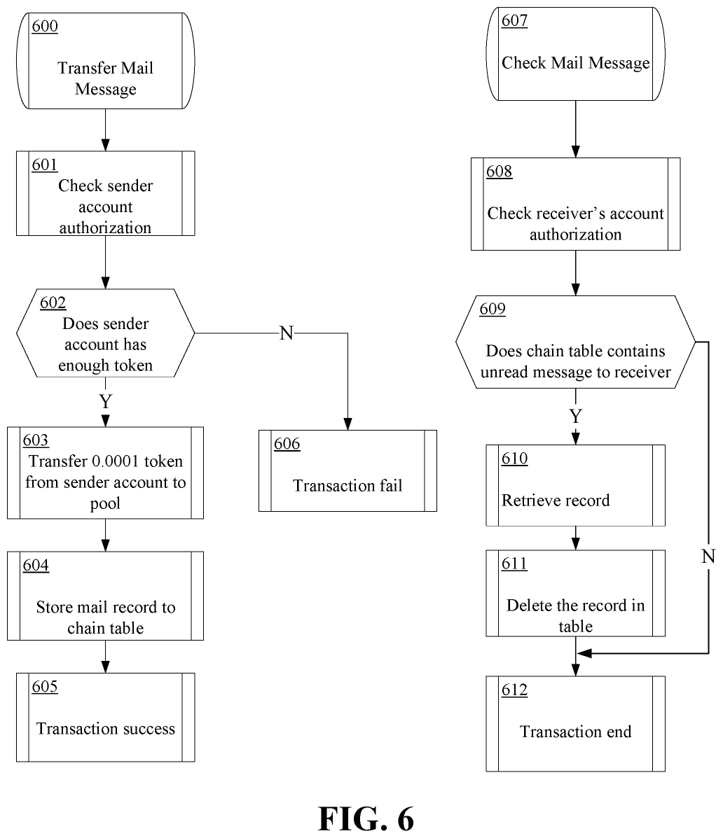

FIG. 6 depicts a flowchart of smart contract email services including sending and checking email. As illustrated, the blockchain email contract includes of two services, one for sending email messages (steps 600-605) and one for checking email messages (steps 607-612).

The services need to ensure that the user has enough tokens to send the email, and the sender of the email is consistent with the sender of the message and has the authority to operate the contract. The services also need to ensure that recipient of the message can only get the message sent to the account, and cannot get any messages sent to others.

The specific processes for the two services are as follows:

### Send Message Service:

At step 600 the process Transfer email message contract invoked.

At step 601, the process checks the sender's authentication and makes sure the operator is the same as the sender's account and has privileges to send out an email message.

At step 602 the process Queries if the sender's account has enough tokens. The account needs to pay a certain amount of tokens to the pool to cover the email transfer expenses.

At step 603 the process if the sender's account has positive tokens after payment, invokes the token transfer contract.

At step 604 the process stores the email record in the blockchain's unread message table.

At step 605, the transaction is declared successful.

At step 606 if the sender's account has negative tokens after payment, the transaction will fail.

### Check Message Service:

At step 607 the process checks the message invoked.

At step 608 the process queries if the recipient account has privileges to receive messages and if the recipient is the same as the current account.

At step 609 the process queries if the chain table contains unread messages.

At step 610 the process finds and retrieves unread messages for the current account.

At step 611 the process deletes message from the unread message table.

At step 612 the transaction ends.

After a new message is received, the smart contract encapsulates the new message into an email agent that is passed to the recipient in JSON (JavaScript Object Notation) format.

To facilitate receiving messages, the blockchain email agent continually monitors the blockchain. When a new block is generated, the blockchain email agent checks if the chain contains unread messages for the current user. It then retrieves the message by calling the receive function of the smart contract. In the contract, only clients providing the corresponding authentication key according to the recipient account can retrieve the message.

Having thus described, by way of example only, embodiments of the present invention, it is to be understood that the invention as defined by the appended claims is not to be limited by particular details set forth in the above description of exemplary embodiments as many variations and permutations are possible without departing from the scope of the claims.

What is claimed is:

1. A blockchain messaging system comprising:
a first blockchain mail agent comprising:
i) a first interface for communication with a first smart contract on a first blockchain;
ii) a second interface for communication with a shared storage;
iii) a third interface for receiving a transmission request for a message from a sender to a recipient,
the first blockchain mail agent receiving the transmission request, determining that a mailbox of the recipient is in a blockchain, and upon said determining:
encrypting content of the message;
saving the encrypted content to the shared storage at a storage index; and
creating a smart contract request for the first smart contract,
wherein the first smart contract generates a transaction record and saves the transaction record in the first blockchain.

2. The blockchain messaging system of claim 1, wherein the message is an email.

3. The blockchain messaging system of claim 2, wherein upon verifying that the mailbox of the recipient is in the shared storage, the blockchain mail agent:
generates a cypher key for said encrypting the content of the email; and
encrypts the storage index and the cypher key with a public key of the recipient.

4. The blockchain messaging system of claim 3, further comprising a second blockchain mail agent, wherein the second blockchain mail agent, upon the first blockchain generating the transaction record associated with the recipient:
i) obtains a public key of the sender;
ii) uses a private key corresponding to the public key of the recipient to decrypt the content of the message to obtain the storage index and the cypher key;
iii) uses the storage index information to retrieve the encrypted content of the email from the shared storage; and
iv) decrypts the content using the cypher key to form a decrypted email content.

5. The blockchain messaging system of claim 4, wherein the first blockchain mail agent and a second blockchain mail agent, are the same.

6. The blockchain messaging system of claim 4, wherein the first blockchain mail agent and a second blockchain mail agent, are different.

7. The blockchain messaging system of claim 6, wherein the mailbox of the recipient is in a second blockchain different from the first blockchain.

8. The blockchain messaging system of claim 4, wherein upon the recipient opening a standard email client, the standard email client communicates with the second mail agent to obtain and present the decrypted email content.

9. The blockchain messaging system of claim 8, wherein the email client uses a standard POP3 protocol to obtain the decrypted email content.

10. The blockchain messaging system of claim 4, wherein the second blockchain mail agent stores the decrypted email content in the mailbox of the recipient.

11. The blockchain messaging system of claim 4, wherein the private key is in a blockchain wallet in the first blockchain.

12. The blockchain messaging system of claim 6, further comprising:
a) a first mail transmission gateway (MTA);
b) a second mail transmission gateway (MTA);
wherein the second blockchain mail agent comprises:
i) a third interface for communication with the second smart contract on the second blockchain; and
ii) a fourth interface for communication with the shared storage, and
wherein the first MTA sends the cypher key and the storage index to the second MTA,
and the second MTA sends the cypher key and the storage index to the recipient.

13. The blockchain messaging system of claim 12, wherein first MTA sends the cypher key and the storage index to the second MTA through regular Internet email.

14. The blockchain messaging system of claim 1, where the transmission request is to a plurality of N receivers and wherein the first smart contract generates N transaction records and saves each of the N transaction records in the first blockchain.

15. A method of secure messaging using a blockchain, comprising:
a) receiving a transmission request for a message from a sender to a recipient, the sender having a sender account on the blockchain;
b) generating a cypher key;
c) encrypting content of the message using the cypher key;
d) storing the encrypted content to a shared storage at a storage index; and
e) encrypting the storage index and the cypher key with a public key of the recipient so that only the recipient having a private key corresponding to the public key of the recipient can access the storage index and cypher key.

16. The method of claim 15, further comprising checking if a mailbox of the recipient is in the blockchain, and if so, executing a smart contract on the blockchain to store a record of a transfer corresponding to the transmission request in the blockchain, but otherwise sending an external message containing the encrypted cypher and storage index.

17. The method of claim 16, further comprising: prior to said executing, ensuring that the sender account is authorized to send a message.

18. The method of claim 17, further comprising: prior to said executing, ensuring the recipient account has at least a first predetermined amount of tokens on the blockchain.

19. The method of claim 18, wherein the recipient has a recipient account on the blockchain, the method further comprising: prior to said executing,
ensuring the recipient account has at least a second predetermined amount of tokens on the blockchain.

20. The method of claim 19, further comprising: ensuring that the receiver account is authorized to receive a message.

21. The method of claim 20, further comprising retrieving the record.

22. The method of claim 21, further comprising deleting the record.
